(19) United States
(12) Patent Application Publication
(10) Pub. No.: US 2016/0138436 A1
(43) Pub. Date: May 19, 2016

(54) METHOD OF REMANUFACTURING A ROCKER ARM AND A REMANUFACTURED ROCKER ARM

(71) Applicant: Caterpillar Inc., Peoria, IL (US)

(72) Inventors: Taylor D. Young, Peoria, IL (US); Luis A. Vazquez, Peoria, IL (US); Curtis J. Graham, Peoria, IL (US); Jonathan R. Eggemeyer, East Peoria, IL (US)

(73) Assignee: Caterpillar Inc., Peoria, IL (US)

(21) Appl. No.: 14/546,439

(22) Filed: Nov. 18, 2014

(51) Int. Cl. F01L 1/18; B23P 15/00

(52) U.S. Cl. CPC F01L 1/181; B23P 15/00

(57) ABSTRACT

A method of remanufacturing a rocker arm having a body defining a contact surface is provided. The contact surface is configured to engage with a braking member and having a worn portion thereon. The method includes machining the contact surface to remove the worn portion and to form an opening configured to receive an insert member therein. The insert member includes an upper surface configured to engage with the braking member. The method further includes coupling the insert member to the opening.

### TECHNICAL FIELD

The present disclosure relates to a rocker arm, and more particularly to methods of remanufacturing a rocker arm.

### BACKGROUND

Rocker arms are typically used in an engine to actuate various valve train components, such as intake and exhaust valves. During normal operation of the engine, the rocker arms may be controlled by a camshaft to actuate the intake and exhaust valves. Such rocker arms may also be used for performing engine braking function. An engine braking system may actuate the rocker arm to open the exhaust valves in order to achieve engine braking. Typically, a component of the engine braking system engages with the rocker arm for actuation. Prolonged engagement of the component with the rocker arm may lead to wear of the rocker arm. Such wear may have an adverse effect on engine braking performance. Therefore, the rocker arm may require replacement.

JP Patent Number H1162517 discloses a sliding component for an internal combustion engine. The sliding component includes a rocker arm body made from a metallic member. Further, the sliding member includes a cermet member containing nickel about 5-40% of weight. The cermet member is integrally joined with the rocker arm body to form the sliding member.

### SUMMARY OF THE DISCLOSURE

In one aspect of the present disclosure, a method of remanufacturing a rocker arm having a body defining a contact surface is provided. The contact surface is configured to engage with a braking member. Further, the contact surface has a worn portion thereon. The method includes machining the contact surface to remove the worn portion and to form an opening configured to receive an insert member therein. The insert member includes an upper surface configured to engage with the braking member. The method further includes coupling the insert member to the opening.

In another aspect of the present disclosure, a rocker arm is provided. The rocker arm includes a body defining a contact surface. Further, an opening is defined in the contact surface. An insert member is at least partially disposed within the opening and coupled thereto. The insert member includes an upper surface disposed adjacent to the contact surface. The upper surface is configured to engage with a braking member.

In yet another aspect of the present disclosure, a rocker arm is provided. The rocker arm includes a body defining a contact surface. Further, an opening is defined in the contact surface. An insert member is partially received within the opening. The insert member includes a base portion having an upper surface configured to engage with a braking member and a lower surface distal from the upper surface. The upper surface is disposed at a height relative to the contact surface. The insert member further includes a leg portion extending from the lower surface. The leg portion is received in the opening and coupled thereto.

Other features and aspects of this disclosure will be apparent from the following description and the accompanying drawings.

### BRIEF DESCRIPTION OF THE DRAWINGS

FIG. 1 is a partial sectional view of an exemplary engine including a rocker arm and an engine braking system;

FIG. 2 is a perspective view of the rocker arm having a contact surface;

FIG. 3 is a perspective view of the rocker arm with an insert member, according to an embodiment of the present disclosure;

FIG. 4 is a partial sectional view of the rocker arm taken along line A-A′ of FIG. 3;

FIG. 5 is a partial longitudinal sectional view of the rocker arm, according to another embodiment of the present disclosure;

FIG. 6 is a partial longitudinal sectional view of the rocker arm, according to yet another embodiment of the present disclosure;

FIG. 7 is a partial longitudinal sectional view of the rocker arm, according to a further embodiment of the present disclosure; and

FIG. 8 is a flowchart of a method of remanufacturing the rocker arm, according to an embodiment of the present disclosure.

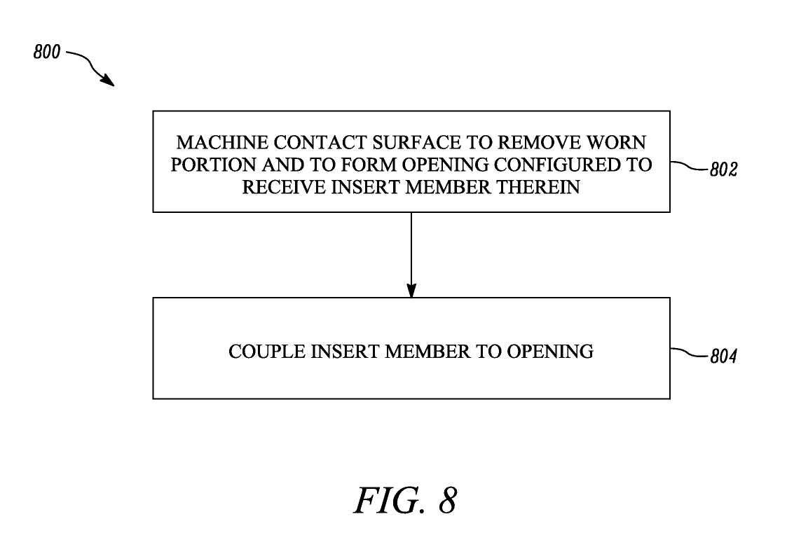

### DETAILED DESCRIPTION

Reference will now be made in detail to specific embodiments or features, examples of which are illustrated in the accompanying drawings. Wherever possible, corresponding or similar reference numbers will be used throughout the drawings to refer to the same or corresponding parts.

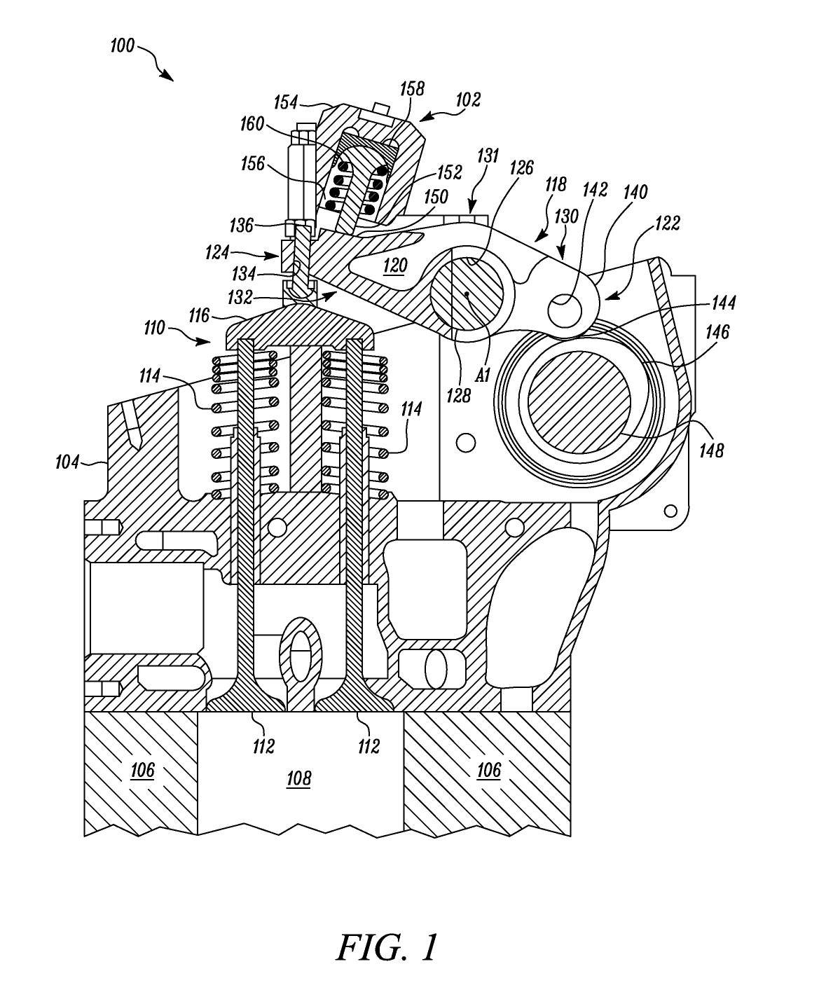

FIG. 1 illustrates a partial sectional view an exemplary engine 100 having an engine braking system 102. The engine 100 may be any internal combustion engine used in various types of industries, for example, construction, transportation, mining, power generation, and the like. The engine 100 may also be used to power various types of machines, for example, excavators, loaders, dozers, mining trucks, electric generators, and the like.

The engine 100 may include a cylinder head 104 and a cylinder block 106. The cylinder block 106 may include one or more cylinders 108. Each of the cylinders 108 may slidably receive a piston (not shown) therein. Each cylinder 108 may include a valve mechanism 110 including a pair of intake valves (not shown) and a pair of exhaust valves 112. Alternatively, the valve mechanism 110 may include any number of intake valves and exhaust valves 112. As shown in FIG. 1, the exhaust valves 112 may be biased to a closed position by a spring 114. The valve mechanism 110 may also include a valve bridge 116 connected to the exhaust valves 112. The valve bridge 116 may be operatively coupled with a rocker arm 118. The rocker arm 118 may be configured to selectively actuate the exhaust valves 112 from the closed position via the valve bridge 116. The pair of intake valves may also be coupled to another valve bridge. The valve bridge may be further coupled to another rocker arm.

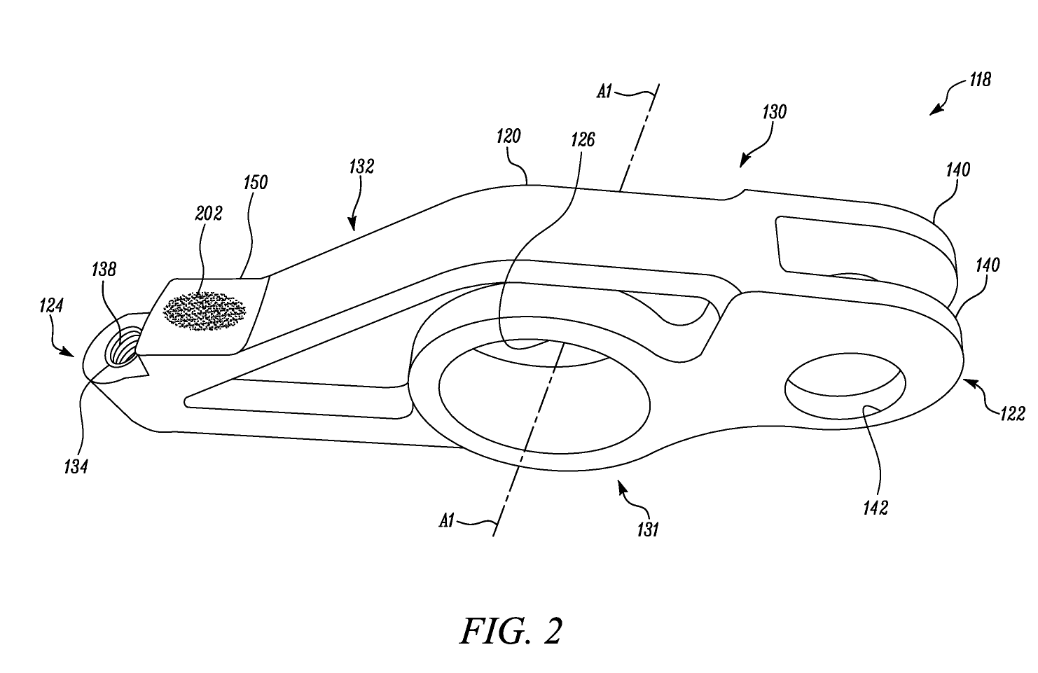

The rocker arm 118 may include a body 120 extending between a first end 122 and a second end 124. The body 120 of the rocker arm 118 may include a first arm 130 extending radially away from a center portion 131 and a second arm 132 extending radially away from the center portion 131 in a direction substantially opposite to the first arm 130. The center portion 131 may define a center hole 126 having a central axis ‘A1’ of rotation. The center hole 126 may be further adapted to receive a shaft 128 therein. The rocker arm 118 may be configured to rotate relative to the shaft 128 about the central axis ‘A1’. The second arm 132 may include a channel 134 proximate to the second end 124. The channel 134 may receive an actuating member 136 therethrough. The channel 134 may include threads 138 (shown in FIG. 2) to engage with corresponding threads (not shown) of the actuating member 136. The actuating member 136 may be coupled to the rocker arm 118 and the valve bridge 116. Thus, the rocker arm 118 may be operatively coupled with the exhaust valves 112 via the actuating member 136 to actuate the exhaust valves 112 from the closed position.

Further, the first arm 130 may include two extensions 140 at the first end 122. Each of the extensions 140 may define apertures 142 that receive a roller 144 therebetween. The roller 144 may be rotatable relative to the extensions 140. Further, the roller 144 may engage with a lobe 146 of a camshaft 148. Thus, the first arm 130 of the rocker arm 118 may be engaged with the camshaft 148 via the roller 144. The camshaft 148 may be rotatably disposed in the cylinder head 104. A person ordinarily skilled in the art may appreciate that the camshaft 148 may include a plurality of lobes along a length in order to actuate corresponding rocker arms associated with the intake valves and the exhaust valves 112 of the cylinders 108.

As shown in FIG. 1, the second arm 132 may include a contact surface 150. The contact surface 150 may be configured to operatively engage with a braking member 152 of the engine braking system 102. The engine braking system 102 may include a housing 154 defining a chamber 156. A brake piston 158 may be slidably received within the chamber 156. The brake piston 158 may be further coupled with the braking member 152. A brake spring 160 may bias the brake piston 158 to a retracted position. The brake piston 158 may be hydraulically actuated from the retracted position against the biasing of the brake spring 160 in order to achieve engine braking

The rocker arm 118, as described above, is for illustrative purposes only, and the first arm 130 engaged with the camshaft 148 and the second arm 132 coupled with the exhaust valves 112 may be of any alternative configuration within the scope of the present disclosure.

During normal operation of the engine 100, the brake piston 158 may be in the retracted position. Based on the rotation of the camshaft 148, the lobe 146 may engage the roller 144. The rocker arm 118 may rotate about the shaft 128 and actuate the exhaust valves 112 from the closed position against the biasing of the springs 114. During engine braking, the brake piston 158 may be hydraulically actuated from the retracted piston. The braking member 152 may move the rocker arm 118 to actuate the exhaust valves 112 from the closed position, thereby achieving engine braking Therefore, during engine braking, a force applied by the braking member 152 on the contact surface 150 may need to overcome the biasing of the springs 114.

FIG. 2 illustrates a perspective view of the rocker arm 118 having a worn portion 202 in the contact surface 150. As shown in FIG. 2, the contact surface 150 may be substantially planar. Further, the contact surface 150 may be hardened by various methods known in the art. In an embodiment, a substrate material of the contact surface 150 may have a hardness of Rockwell 15N 85 with a case depth of at least 0.2 mm. Due to prolonged contact with the braking member 152, the worn portion 202 may be created on the contact surface 150. The worn portion 202 may be formed due to rubbing with the braking member 152 during normal operation of the engine 100 and/or force exerted by the braking member 152 during engine braking The worn portion 202 may form a recessed area relative to a surrounding portion of the contact surface 150. Dimensional changes in the worn portion 202 may alter performance of the engine braking system 102. Specifically, actuation of the exhaust valves 112 from the closed position may vary for a given movement of the braking member 152. The rocker arm 118 can be remanufactured so that the rocker arm 118 may provide an intended actuation of the exhaust valves 112 corresponding to a given movement of the braking member 152.

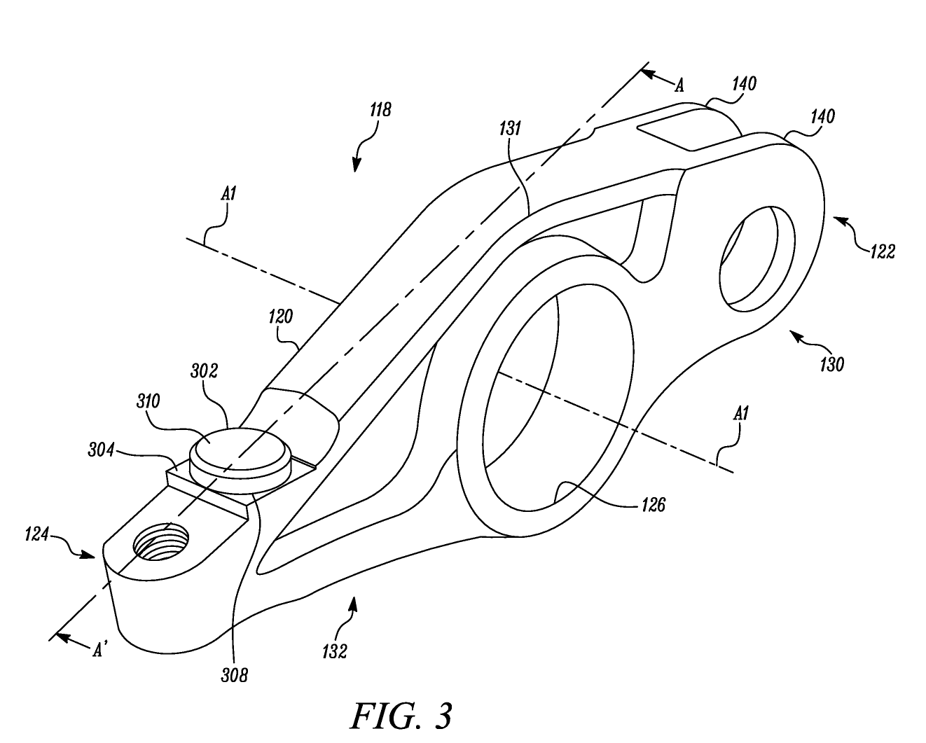

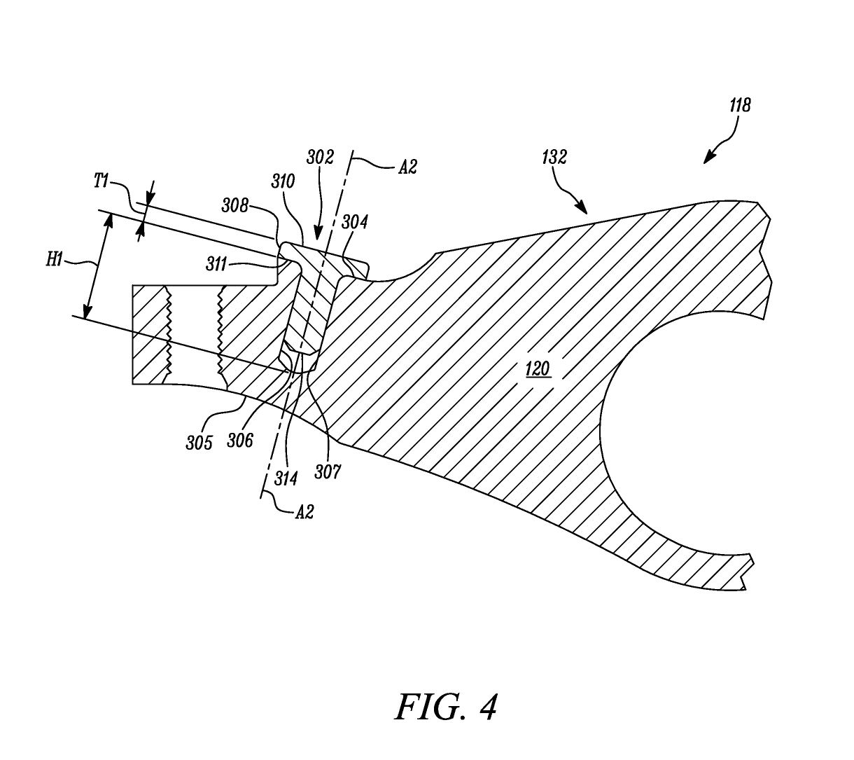

FIG. 3 illustrates a perspective view of the rocker arm 118 with an insert member 302, according to an embodiment of the present disclosure. FIG. 4 illustrates a partial sectional view of the rocker arm 118 taken along line A-A′ of FIG. 3. Referring to FIGS. 3 and 4, the rocker arm 118 may include a contact surface 304 adjacent to the second end 124 thereof. In an embodiment, the contact surface 304 may correspond to an intermediate surface formed by machining the contact surface 150 (the original contact surface shown in FIG. 2) of the rocker arm 118. The contact surface 150 may be machined to a predetermined depth to form the intermediate surface, and hence the worn portion 202 is removed from the rocker arm 118. The machining may include grinding, honing, milling, turning, or a combination thereof. The intermediate surface may be substantially planar. Alternatively, the intermediate surface may be curvilinear.

Further, an opening 306 may be defined in the contact surface 304. The insert member 302 may be at least partially disposed in the opening 306. The contact surface 304 may be machined to from the opening 306. The opening 306 may extend from the contact surface 304 into the body 120 of the rocker arm 118 along an axis ‘A2’. The axis ‘A2’ of the opening 306 may be substantially perpendicular to a plane of the contact surface 304. In the illustrated embodiment, the opening 306 may be a blind hole. In an alternative embodiment, the opening 306 may be a through hole extending from the contact surface 304 to a bottom surface 305 of the body 120. Further, the opening 306 may be defined by a wall 307. In an embodiment, the opening 306 may have a circular cross-section. However, the opening 306 may have any alternative cross-sectional shape, for example, polygonal, elliptical, and the like. The opening 306 may be formed by machining the contact surface 304 to a depth ‘H1’ into the body 120. The machining may include drilling, boring, reaming, turning, or a combination thereof.

Referring to FIGS. 3 and 4, the insert member 302 may include a base portion 308 having an upper surface 310. The upper surface 310 of the insert member 302 may be disposed adjacent to the contact surface 304. The upper surface 310 may be configured to engage with the braking member 152 of the engine braking system 102. The base portion 308 may further include a lower surface 311 distal from the upper surface 310. The lower surface 311 may abut the contact surface 304. A plane defined by the lower surface 311 may be parallel to a plane defined by the upper surface 310. Thus, the base portion 308 may have a thickness ‘T1’ between the upper surface 310 and the lower surface 311. The thickness ‘T1’ of the base portion 308 may be substantially equal to the predetermined depth to which the contact surface 150 is machined. The insert member 302 may further include a leg portion 314 extending from the lower surface 311 of the base portion 308. The leg portion 314 may extend substantially perpendicular to the plane defined by the lower surface 311. The leg portion 314 may be configured to be received in the opening 306. A length of the leg portion 314 may be equal to or less than the depth ‘H1’ of the opening 306. The leg portion 314 may include a circular cross section. However, it may be contemplated that the leg portion 314 may have any other cross-section corresponding to the cross section of the opening 306.

Further, the insert member 302 may be coupled with the opening 306. In an embodiment, a width of an outer surface of the leg portion 314 may be greater than a width of the opening 306 such that the insert member 302 may be press fitted to the opening 306. Further, as the thickness ‘T1’ of the base portion 308 is equal to the predetermined depth to which the contact surface 150 is machined, the upper surface 310 of the base portion 308 may be located at a height same as the contact surface 150 relative to the body 120 of the rocker arm 118.

The insert member 302, as described above, is exemplary in nature and various alternative configurations are possible within the scope of the present disclosure. For example, the base portion 308 of the insert member 302 may include chamfers and/or fillets. Further, the width of the leg portion 314 may vary along a length thereof.

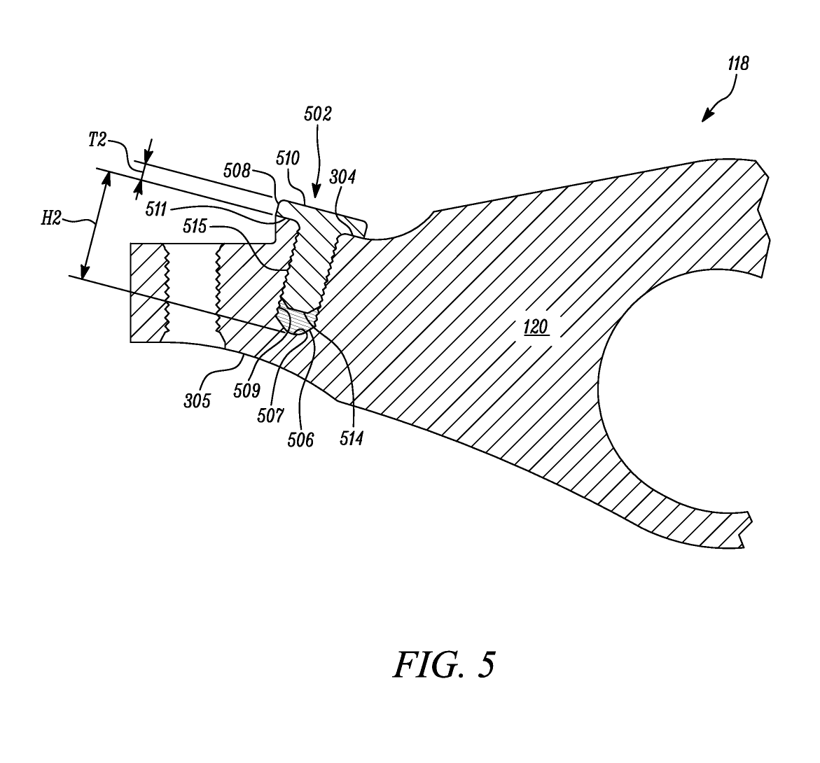

FIG. 5 is a partial sectional view of the rocker arm 118, according to another embodiment of the present disclosure. Referring to FIG. 5, the contact surface 304 may be machined to define an opening 506. The opening 506 may extend from the contact surface 304 into the body 120 of the rocker arm 118. In the illustrated embodiment, the opening 506 may be a blind hole extending substantially perpendicular to the plane of the contact surface 304. In an alternative embodiment, the opening 506 may be a through hole extending from the contact surface 304 to the bottom surface 305 of the body 120. Further, a wall 507, defining the opening 506, may include threads 509. The threads 509 may be machined on the wall 507 by one or more machining processes such as turning, milling, or any other method known in the art. The opening 506 may be formed by machining the contact surface 304 to a depth ‘H2’ into the body 120.

Further, an insert member 502 may include a base portion 508 having an upper surface 510. The upper surface 510 may be configured to engage with the braking member 152 of the engine braking system 102. The base portion 508 may include a lower surface 511 distal from the upper surface 510. The base portion 508 may have a thickness ‘T2’ between the upper surface 510 and the lower surface 511. The insert member 502 may further include a leg portion 514 extending from the lower surface 511 of the base portion 508. The leg portion 514 may extend substantially perpendicular to a plane defined by the lower surface 511. The leg portion 514 may be received within the opening 506. A length of the leg portion 514 may be equal to or less than the depth ‘H2’ of the opening 506. Threads 515 may be provided on an outer surface of the leg portion 514. Thus, the insert member 502 may be threadingly coupled with the opening 506. Specifically, the threads 515 of the leg portion 514 may be engaged with the corresponding threads 509 of the opening 506 such that the upper surface 510 of the insert member 502 may be disposed adjacent to the contact surface 304 to engage with the braking member 152.

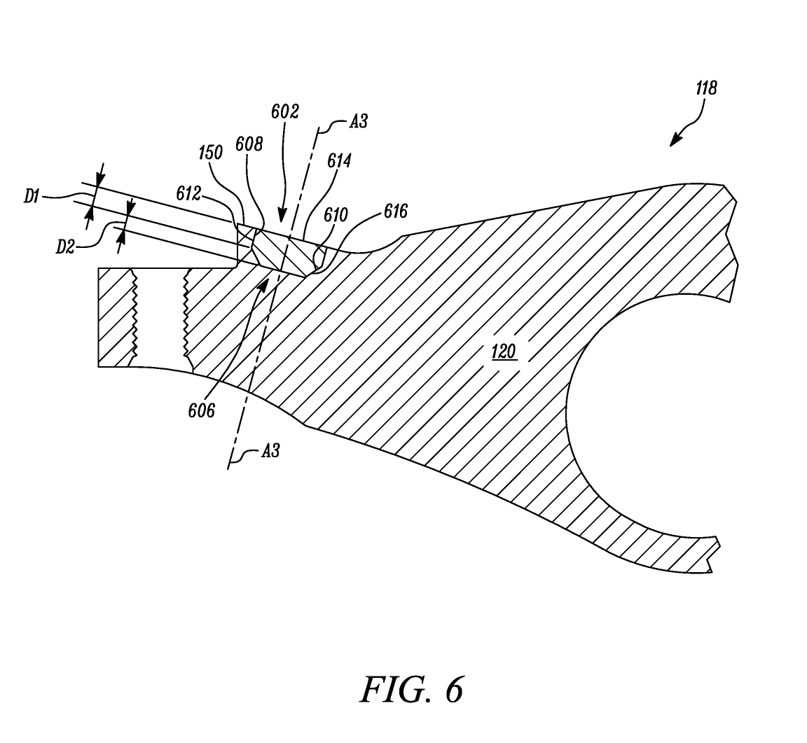

FIG. 6 is a partial sectional view of the rocker arm 118, according to yet another embodiment of the present disclosure. The body 120 of the rocker arm 118 may define the contact surface 150. An opening 606 may be defined in the contact surface 150. In an embodiment, the worn portion 202 (shown in FIG. 2) in the contact surface 150 may be machined to form the opening 606. The opening 606 may extend from the contact surface 150 into the body 120 of the rocker arm 118. The opening 606 may include a cylindrical opening 608 extending from the contact surface 150 into the body 120 along an axis ‘A3’. The axis ‘A3’ may be perpendicular to a plane of the contact surface 150. The cylindrical opening 608 may be formed by machining the contact surface 150 to a first depth ‘D1’ into the body 120. The opening 606 may further include a frustoconical opening 610 adjacent to the cylindrical opening 608 along the axis ‘A3’. The frustoconical opening 610 may be formed by machining to a second depth ‘D2’ from the cylindrical opening 608. The machining may include drilling, boring, reaming, turning, or a combination thereof.

The rocker arm 118 may further include an insert member 602 configured to be disposed within the opening 606. Specifically, the insert member 602 may include a cylindrical portion 612 configured to be received within the cylindrical opening 608. The cylindrical portion 612 may have a shape substantially similar to a shape defined by the cylindrical opening 608. The cylindrical portion 612 may include an upper surface 614 configured to engage with the braking member 152 of the engine braking system 102. In the illustrated embodiment, the upper surface 614 may be substantially planar. The cylindrical portion 612 may have a thickness substantially equal to the first depth ‘D1’ of the cylindrical opening 608. The insert member 602 may further include a frustoconical portion 616 configured to be received within the frustoconical opening 610. An outer surface of the frustoconical portion 616 may have a shape substantially similar to a shape defined by the frustoconical opening 610. The frustoconical portion 616 may extend from the cylindrical portion 612 distal to the upper surface 614. Further, the frustoconical portion 616 may have a thickness substantially equal to the second depth ‘D2’ of the frustoconical opening 610.

The insert member 602 may be further coupled with the opening 606. In the illustrated embodiment, the insert member 602 may be press fitted with the opening 606. A diameter of the cylindrical portion 612 may be greater than a diameter of the cylindrical opening 608 such that the insert member 602 may be press fitted within the opening 606. Alternatively, the insert member 602 may be welded to the opening 606. In the coupled position of the insert member 602 within the opening 606, as shown in FIG. 6, the upper surface 614 may be flush with the contact surface 150. Hence, the upper surface 614 and the surrounding contact surface 150 may together form a substantially planar surface configured to engage with the braking member 152 (shown in FIG. 1).

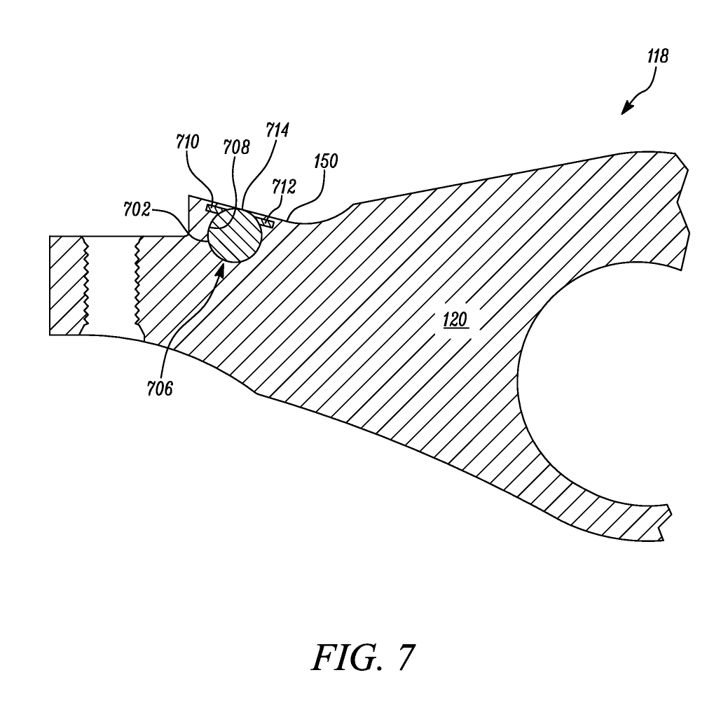

FIG. 7 is a partial sectional view of the rocker arm 118, according to a further embodiment of the present disclosure. The contact surface 150 of the rocker arm 118 may define an opening 706. In an embodiment, the worn portion 202 (shown in FIG. 2) of the contact surface 150 may be machined to form the opening 706. The opening 706 may include a spherical opening 708 machined in the body 120 of the rocker arm 118. The machining may include drilling, boring, reaming, turning, or a combination thereof. The opening 706 may further include a fastener opening 710. The fastener opening 710 may be an internal groove formed within the body 120 adjacent to the spherical opening 708. In alternative embodiments, the fastener opening 710 may be a groove formed on the contact surface 150.

The rocker arm 118 may further include an insert member 702 configured to be disposed within the opening 706. The insert member 702 may be a ball. The ball may be configured to be received within the spherical opening 708. The ball may have a shape substantially similar to a shape defined by the spherical opening 708. The rocker arm 118 may further include a fastening member 712 configured to be disposed within the fastener opening 710. The fastening member 712 may be a circlip. Further, the fastening member 712 may be configured to retain the insert member 702 in the spherical opening 708. In the retained position of the insert member 702, as shown in FIG. 7, an upper surface 714 of the insert member 702 may be flush with the contact surface 150. Hence, the upper surface 714 of the insert member 702 and the contact surface 150 may together engage with the braking member 152 of the engine braking system 102.

### INDUSTRIAL APPLICABILITY

An engine typically includes multiple rocker arms for actuating the exhaust valves and inlet valves. The rocker arm, which is associated with the exhaust valves, may be engaged with an engine braking system. The engine braking system may be configured to actuate the rocker arm to move the exhaust valves from a closed position during engine braking A braking member of the engine braking system may engage with a contact surface of the rocker arm for actuating the exhaust valves. Over a period of time, this may lead to wear of the rocker arm, thereby affecting an engine braking performance. Therefore, the rocker arm may need to be remanufactured in order to be reused with the engine braking system.

The present disclosure relates to a method 800 of remanufacturing the rocker arm 118. Referring to FIGS. 3 and 4, at step 802, the method 800 includes machining the contact surface 150 to remove the worn portion 202 and to form the opening 306, according to an embodiment of the present disclosure. In an exemplary machining process, the rocker arm 118 may be mounted on a fixture associated with a machine tool. The machine tool may be one of a milling machine, a lathe machine and the like. The rocker arm 118 may be secured to the fixture by any one or combination of fastening methods such as bolting, clamping, and any other method known in the art. The rocker arm 118 may be mounted on the fixture in order to machine the contact surface 150 to the predetermined depth and obtain the intermediate surface. The contact surface 150 may be machined in one or more stages. The predetermined depth may be equal to the thickness ‘T1’ of the base portion 308 of the insert member 302. The intermediate surface may be a planar surface. The intermediate surface may correspond to the contact surface 304.

Further, the intermediate surface may be machined in order to form the opening 306. The intermediate surface may be machined by one of drilling, boring, reaming, turning, or a combination thereof. The axis ‘A2’ of the opening 306 may be perpendicular to the plane of the contact surface 304. The opening 306 may be formed in one or more machining stages. The opening 306 may be configured to receive the leg portion 314 of the insert member 302. In the embodiment shown in FIGS. 3 and 4, the opening 306 may be a blind hole. However, in alternative embodiment, the opening 306 may be a through hole.

Referring to FIG. 5, in another embodiment, the method 800 may include machining the intermediate surface to form the opening 506. Further, the method 800 may also include machining threads 509 on the wall 507 defining the opening 506. The threads 509 may be configured to engage with the threads 515 provided on the leg portion 514 of the insert member 502.

Referring to FIG. 6, in yet another embodiment, the method 800 may include machining the contact surface 150 to remove the worn portion 202 and form the opening 606. Machining the contact surface 150 may include machining the cylindrical opening 608 extending from the contact surface 150 into the body 120 of the rocker arm 118. The cylindrical opening 608 may be configured to receive the cylindrical portion 612 of the insert member 602. Further, the cylindrical opening 608 may be formed by machining the contact surface 150 to the first depth ‘D1’ into the body 120. The method 800 may further include machining the body 120 to form the frustoconical opening 610 adjacent to the cylindrical opening 608 along the axis ‘A3’. Specifically, the frustoconical opening 610 may be formed by machining to the second depth ‘D2’ from the cylindrical opening 608. The frustoconical opening 610 may be configured to receive the frustoconical portion 616 of the insert member 602.

Referring to FIG. 7, in a further embodiment, the method 800 of machining the contact surface 150 may include machining the contact surface 150 to remove the worn portion 202 and form the opening 606. The opening 706 may include the spherical opening 708. The contact surface 150 of the rocker arm 118 may be machined to form the spherical opening 708 corresponding to the outer surface of the insert member 702. The insert member 702 may be a ball. Further, the fastener opening 710 may be machined in the contact surface 150 adjacent to the spherical opening 708 to receive the fastening member 712.

Referring to FIGS. 3 and 4, at step 804, the method 800 includes coupling the insert member 302 to the opening 306. In an embodiment of the present disclosure, the insert member 302 may be coupled to the opening 306 by press fitting. In an example, the insert member 302 may be driven into the opening 306 by a machine (e.g., a hydraulic press) to press fit the insert member 302 to the opening 306. Specifically, a press fit may be provided between the leg portion 314 and the opening 306. In the coupled position of the insert member 302, the base portion 308 may be disposed adjacent to the intermediate surface. Further, the thickness ‘T1’ of the base portion 308 may be equal to the predetermined depth of machining of the contact surface 150 (the original contact surface shown in FIG. 2). Hence, the upper surface 310 of the base portion 308 may be located at a same height as the contact surface 150 relative to the body 120 of the rocker arm 118. Moreover, the upper surface 310 may be configured to engage with the braking member 152 of the engine braking system 102.

Referring to FIG. 5, in another embodiment of the present disclosure, the insert member 502 may be coupled to the opening 506 by engaging the threads 515 provided on the leg portion 514 of the insert member 502 with the threads 509 of the opening 506.

Referring to FIG. 6, in yet another embodiment of the present disclosure, the insert member 602 may be coupled to the opening 606 by press fitting. Specifically, the cylindrical portion 612 and the frustoconical portion 616 may be engaged with the cylindrical opening 608 and the frustoconical opening 610, respectively. In the coupled position of the insert member 602, the upper surface 614 of the insert member 602 may be flush with the contact surface 150. Further, the upper surface 614 may be configured to engage with the braking member 152 of the engine braking system 102. In an alternative embodiment, the insert member 602 may be welded to the opening 606.

Referring to FIG. 7, in a further embodiment of the present disclosure, the insert member 702 may be disposed within the spherical opening 708. The fastening member 712 may be further disposed within the fastener opening 710 to retain the insert member 702 in the spherical opening 708.

In an embodiment, a hardness of a material of each of the insert members 302, 502, 602, 702 may be higher than the hardness of a material of the rocker arm 118. For example, the insert member 302, 502, 602, 702 may be made from a material having a hardness of at least Rockwell 30N 77. The insert member 302, 502, 602, 702 may consequently sustain reduced wear and result in a longer operational life of the remanufactured rocker arm. Further, the upper surfaces 310 and 510 of the insert members 302 and 502 respectively, may have a shape substantially similar to the contact surface 150. Further, the upper surfaces 310 and 510 may be located at the same height as the contact surface 150 relative to the body 120 of the rocker arm 118. The upper surfaces 310 and 510 may therefore provide an equivalent engine braking as the contact surface 150. Further, the upper surfaces 614 and 714 of the insert members 602 and 702, respectively, may be flush with the contact surface 150. Hence, an engine braking provided by the contact surface 150, with the insert members 602 and 702, may remain unchanged. The method 800 may therefore enable an existing rocker arm with wear to be remanufactured so as to be reusable in an engine. For example, the remanufactured rocker arm may be reused in the engine 100. This may be cost efficient as compared to replacement of the existing rocker arm with a new rocker arm.

Further, the insert member disposed in the remanufactured rocker arm may be replaced when the upper surface of the insert member undergoes wear due to prolonged usage. Thus, the remanufactured rocker arm may be repeatedly used in the engine 100 by just replacing the insert members.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A method of remanufacturing a rocker arm having a body defining a contact surface, the contact surface configured to engage with a braking member and having a worn portion thereon, the method comprising:
machining the contact surface to remove the worn portion and to form an opening configured to receive an insert member therein, wherein the insert member comprises an upper surface configured to engage with the braking member; and
coupling the insert member to the opening.

2. The method of claim 1, further comprising machining the contact surface to a predetermined depth to create an intermediate surface.

3. The method of claim 2, further comprising machining the intermediate surface to form the opening.

4. The method of claim 2, wherein coupling the insert member to the opening comprises press-fitting a leg portion of the insert member to the opening such that a base portion of the insert member is disposed adjacent to the intermediate surface, wherein the base portion comprises the upper surface configured to engage with the braking member.

5. The method of claim 4, wherein the predetermined depth is equal to a thickness of the base portion.

6. The method of claim 1, further comprising machining threads on a wall defining the opening.

7. The method of claim 6, wherein coupling the insert member to the opening comprises engaging corresponding threads provided on the leg portion of the insert member with the threads on the wall defining the opening.

8. The method of claim 1, wherein the opening is one of a blind hole and a through hole.

9. The method of claim 1, wherein a hardness of a material of the insert member is greater than a hardness of a material of the rocker arm.

10. The method of claim 1, wherein machining the contact surface comprises:
machining a cylindrical opening extending from the contact surface into the body of the rocker arm, the cylindrical opening configured to receive a cylindrical portion of the insert member, wherein the cylindrical portion comprises the upper surface configured to engage with the braking member, the upper surface being flush with the contact surface; and
machining a frustoconical opening adjacent to the cylindrical opening, the frustoconical opening configured to receive a frustoconical portion of the insert member.

11. The method of claim 1, wherein machining the contact surface comprises:
machining a spherical opening configured to receive the insert member therein; and
machining a fastener opening configured to receive a fastening member, the fastening member configured to retain the insert member in the spherical opening.

12. A rocker arm comprising:
a body defining a contact surface;
an opening defined in the contact surface; and
an insert member at least partially disposed within the opening and coupled thereto, the insert member having an upper surface disposed adjacent to the contact surface and configured to engage with a braking member.

13. The rocker arm of claim 12, wherein the body comprises:
a first arm extending radially away from a center portion, the first arm configured to operatively engage a cam shaft;
a second arm extending radially away from the center portion in a direction substantially opposite the first arm, the second arm configured to operatively engage a valve mechanism, wherein the center portion defines a center hole having a central axis of rotation, the contact surface being located on the second arm.

14. The rocker arm of claim 12, wherein the insert member comprises:
a base portion having the upper surface and a lower surface distal from the upper surface; and
a leg portion extending from the lower surface of the base portion, wherein the leg portion is received in the opening and coupled thereto.

15. The rocker arm of claim 12, wherein the opening is one of a blind hole and a through hole.

16. The rocker arm of claim 14, wherein the leg portion of the insert member comprises threads configured to engage with corresponding threads provided in a wall defining the opening.

17. The rocker arm of claim 12, wherein the opening comprises:
a cylindrical opening extending from the contact surface into the body of the rocker arm configured to receive a cylindrical portion of the insert member, wherein the cylindrical portion comprises the upper surface configured to engage with the braking member, the upper surface being flush with the contact surface; and
a frustoconical opening adjacent to the cylindrical opening configured to receive a frustoconical portion of the insert member.

18. The rocker arm of claim 12, wherein the insert member is a ball, and wherein the opening comprises:
a spherical opening configured to receive the ball therein; and
a fastener opening configured to receive a fastening member, the fastening member further configured to retain the ball in the spherical opening.

19. A rocker arm comprising:
a body defining a contact surface;
an opening defined in the contact surface; and
an insert member partially received within the opening, the insert member comprising:
a base portion having an upper surface configured to engage with a braking member and a lower surface distal from the upper surface, wherein the upper surface is disposed at a height relative to the contact surface; and
a leg portion extending from the lower surface, wherein the leg portion is received in the opening and coupled thereto.

20. The rocker arm of claim 19, wherein the opening is one of a through hole and a blind hole.
